(19) United States
(12) Patent Application Publication
(10) Pub. No.: US 2017/0330121 A1
(43) Pub. Date: Nov. 16, 2017

(54) SYSTEM AND METHODS FOR EXECUTION OF MULTI-NATIONAL BUSINESS PROCESSES

(71) Applicant: NETSUITE INC., SAN MATEO, CA (US)

(72) Inventors: CRAIG SULLIVAN, KINGSBURG, CA (US); STEPHEN CLODE, SAN JOSE, CA (US); ROBERT MCKELLIGAN, SAN MATEO, CA (US)

(21) Appl. No.: 15/595,061

(22) Filed: May 15, 2017

Related U.S. Application Data
(60) Provisional application No. 62/337,125, filed on May 16, 2016.

(51) Int. Cl. G06Q 10/06; G06Q 40/00

(52) U.S. Cl. CPC G06Q 10/06313; G06Q 40/10

(57) ABSTRACT

A system and methods for allowing a business to create rules and automate the impact of a transaction (such as a sales order) across the various legal entities that are involved. These entities may be located in different jurisdictions, with each subject to differing tax, accounting, safety, consumer protection, or other rules or regulations. The overall transaction processing is relatively difficult in conventional systems, which are separate and typically require complex technical integration, while also being prone to error and fragility. However, because the underlying system/platform used in implementing embodiments of the inventive methods contains data and business logic applicable to both entities involved in each stage of a transaction or service delivery process, those embodiments enable businesses to create rules and automate the impact of executing a transaction or other operation across the various participating entities.

### CROSS REFERENCE TO RELATED APPLICATION

This application claims the benefit of U.S. Provisional Application No. 62/337,125, entitled “System and Methods for Execution of Multi-National Business Processes,” filed May 16, 2016, which is incorporated by reference herein in its entirety (including the Appendix) for all purposes.

### BACKGROUND

Multi-national corporations typically organize their operational structure and the allocation of specific functions across regional sub-units (which may be located in different counties, states, countries, etc.) on considerations of one or more of tax incentives, labor costs, labor availability, access to the needed forms of transportation, access to capital, and other factors that affect the viability and/or profitability of the corporation. However, in order to be effective, these functional units may need to interact with each other and with customers or other users. This can create difficulties with regards to how costs and revenue are allocated between the functional units when satisfying accounting requirements or regulations in the locations in which the corporation has a presence.

For example, the legal structure(s) (i.e., a governmental or regulatory entity, such as cities, counties, states, countries, regions, etc.) in which a corporation operates dictate when and where business units must have accounting books, financial statements, and participate in local and regional tax filings. A company may ignore these sub-entity distinctions (in an operational sense) in order to execute their business processes in the most optimal way (e.g., fulfill inventory owned by one entity for a sale booked to another entity, or assign an employee of one entity to work on a project that will be billed to a customer of another entity). Such operational processes that span across a company's subsidiaries (and operate in multiple legal entities) result in complicated inter-subsidiary (sometimes referred to as Intercompany, IC) accounting tasks and are typically addressed or reconciled by manual labor. For example, special rules dictate taxation in such cases, there are several models for transfer pricing, and there are complex accounting structures used to minimize income taxes.

However, conventional enterprise resource planning (ERP) systems depend on managing these situations using a manual and tedious process that accountants perform at month end to close the books. While being an inefficient use of labor, this conventional approach is also prone to human error. A further disadvantage is that such an approach may prevent a corporation from implementing rules or procedures that may be desirable from an operational and/or from a compliance perspective, and which if implemented, would improve the operation of the company as a whole.

As suggested, multi-national corporations encounter certain types of issues that may not occur in the situation of a corporation being resident in a single country or jurisdiction. For example, if a multi-national corporation has a structure wherein one or more of the primary functional entities (e.g., manufacturing, order processing, order fulfillment, field engineering, customer service, etc.) are located in different jurisdictions, then the overall process of receiving and fulfilling an order requires that each legal entity involved record the relevant activities in their systems to provide a full picture of the business activity for local reporting purposes. Further, properly recording the aspects of an order may require that subsidiary entities deal with the financial or accounting ramifications of the order to support both local compliance and as part of a company's internal accounting and financial practices. For example, if accounting, revenue recognition, consumer protection, or other rules or regulations differ between two jurisdictions in which a corporation's business units are located, then proper accounting or other financial considerations may require various data processing and conversions to enable each business unit to properly reflect a transaction.

Conventional approaches to providing these functions for a transaction that “touches” or interacts with multiple legal structures are typically based on a set of separate functional modules, each with their own database and application environment. While this may be suitable for some businesses, it is not easily scalable and may be prone to errors with regards to synchronization of data, timeliness of data, and the overall integration of the separate functions. In addition, a substantial amount of effort may be required by employees to ensure that all data relevant to a transaction is available, having been entered into each relevant system or sub-system. Such conventional approaches lead to inefficiency in administration and the addition of layers of business processes and approvals to comply with the local reporting requirements and meet the needs of each legal entity, adding no value to the business overall and potentially hampering the ability of the business to compete and meet the expectations of its customers and vendors.

Embodiments of the inventive system and methods are directed to overcoming the limitations associated with conventional approaches to providing these accounting, financial, management and transaction execution capabilities, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the inventive system and methods are directed to creating an accounting/ERP framework that enables cross-subsidiary (and cross-jurisdictional) workflows, and automates the generation of Intercompany financials according to how a finance department wishes to structure them. In some embodiments, this is accomplished by providing a generalized system for handling the multiple types of operational workflows that an ERP system may implement.

Embodiments of the inventive system and methods allow businesses to represent their organizational structure within a data processing platform (such as a multi-tenant platform of the type described herein), define trading relationships and exclusions across the various legal entities, create rules, establish transfer pricing methods and automate the impact of an operational and accounting transaction (such as a sales order) across the various legal entities that are involved (which may be represented by different operational units or subsidiaries of the company). These entities may be located in different jurisdictions, with each subject to differing tax, accounting, safety, consumer protection, or other rules or regulations. This type of transaction processing is relatively difficult in conventional systems, which are separate and typically require complex technical integration, while also being prone to error and fragility. However, because the underlying system/platform used in implementing some embodiments of the inventive methods contains data and business logic applicable to both entities involved in each stage of a transaction or service delivery process (such as order generation, fulfillment, inventory management, payment and reconciliation, customer support, etc.), those embodiments enable businesses to create rules and automate the impact of executing a transaction or other operation across the various participating entities.

The inventive solutions permit each separate entity for purposes of rules or regulations, and the multi-national organization as a whole, to ensure proper tracking and compliance with the relevant tax, accounting, safety, consumer protection and other regulations or rules of multiple jurisdictions. Thus, the structure and architecture of the service platform described herein provides an efficient and reliable mechanism for handling orders, fulfillment, payment, inventory management, and other services that may be provided by or implemented in different regions, jurisdictions or countries, while enabling the corporation's finance function to operate as needed for purposes of the corporation.

Note that the term “entity” as used herein may include, but is not restricted to, a division, operating unit, functional department, subsidiary company or similar aspect of an organization, with one or more of such entities being subject to potentially different rules or regulations than the others. The rules or regulations may relate to accounting, taxation, securities reporting, consumer protection, or another operating area in which different jurisdictions (such as regions, countries, states, etc.) may have different approaches or requirements.

Because in some embodiments a business is using the same service platform to support all of their entities (whether domestic or foreign based) as a form of “subsidiary”, the inventive system has the ability to utilize all of the configuration information for those entities when they interact/transact with each other (e.g., a retail subsidiary ‘buys’ product from the distribution subsidiary, or a sales subsidiary utilizes implementation resources from another subsidiary). As a result, a corporation can efficiently and accurately “charge” or “reallocate” items or amounts between its subsidiary entities based on specific operational features of the corporation, while ensuring compliance with any relevant rules or regulations.

In one embodiment, the invention is directed to a data processing platform, where the platform includes:
an application or applications installed on the data processing platform;
a tenant account configured to have access to an instantiation of the application or applications installed on the data processing platform;
a database storing data for the tenant account, the database including data records containing information regarding products and services offered to customers by the tenant, and data records containing information regarding each of the entities that are part of the tenant's business organization;
an electronic processing element programmed with a set of computer-executable instructions, which when executed, cause the platform to
   provide a user of the tenant account with an interface for specifying a workflow to be used for processing a transaction initiated by a customer of the tenant, wherein the workflow includes an action performed by at least two entities that are part of the tenant's business organization;
   based on the workflow, generate one or more data records for the transaction, the generated records including records used to satisfy relevant legal or accounting requirements;
   access data stored in the database relating to the at least two entities that are part of the tenant's business organization, wherein the accessed data includes one or more of an entity's location or an entity's currency; and
   based on the workflow and the accessed data, process the transaction.

In another embodiment, the invention is directed to a method of processing a transaction where portions of the transaction are performed by different entities of a business organization, and where the method includes:
providing a user with an interface for specifying a workflow to be used for processing the transaction, wherein the workflow includes an action performed by at least two entities that are part of the business organization and that are subject to differing requirements;
receiving from the user a selection or identification of one or more functions, operations, processes, or actions to be performed;
based on the received functions, operations, processes, or actions to be performed, generate one or more data records for the transaction, the generated records including records used to satisfy relevant legal or accounting requirements;
access data stored in a database relating to the at least two entities that are part of the business organization, wherein the accessed data includes one or more of an entity's location or an entity's currency; and
based on the workflow and the accessed data, process the transaction, wherein processing the transaction includes populating the generated data records in order to satisfy the relevant legal or accounting requirements.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating a system, including an integrated business system and an enterprise network in which an embodiment of the invention may be implemented;

FIG. 2 is a diagram illustrating elements or components of an example operating environment in which an embodiment of the invention may be implemented;

FIG. 3 is a diagram illustrating additional details of the elements or components of the multi-tenant distributed computing service platform of FIG. 2, in which an embodiment of the invention may be implemented;

FIG. 4 is a diagram illustrating some of the processes involved in a use case of an embodiment of the inventive system and methods;

FIG. 5 is a diagram illustrating elements or components that may be present in a computer device or system configured to implement a method, process, function, or operation in accordance with an embodiment of the invention;

FIG. 6 is a diagram illustrating an example overview of the data flow, characteristics, and operations that may be present in the processing of a transaction, where the processing is implemented in accordance with an embodiment of the inventive system and methods; and

FIG. 7 is a diagram illustrating additional details regarding the functions or operations that may be performed as part of the intercompany framework setup, operations, and true-up processes or functions shown in FIG. 6.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the invention provide elements and processes that enable a business to more efficiently manage the execution of a transaction and the related financial reconciliation tasks in a situation where the transaction involves operating units and processes that span multiple legal entities (such as entities in multiple jurisdictions subject to differing tax, accounting, safety, consumer protection or other regulations or requirements). Benefits and advantages of embodiments of the inventive system and methods may include, but are not limited to, the following:
enabling further optimization of global business processes operating in a remote hosted environment (“in the cloud”);
removing significant manual effort and administrative bottlenecks for implementing and executing inter-subsidiary business processes that can be partially or fully automated using the invention(s) described herein; and
as a result, bringing the flexibility and agility of a startup to global organizations.

Note that embodiments of the inventive system and methods operate to minimize the user involvement required in the reconciliation and other financial operations, and that the processes, operations and accounting functions are automated to the extent possible through the definition of the trading environment and the accounting compliance required of each business operation when a transaction occurs between subsidiaries. From the set-up of a user's organization within the platform, through the generation of the accounting and compliance records used in a business transaction(s), to the user defined scheduling or accounting “true up”, and finally to the elimination and settlement processes, embodiments of the invention offer an automated solution that overcomes disadvantages of conventional approaches. Note that in conventional systems, this would typically require an intercompany consolidation and elimination process, and manual processes for purposes of settlement.

In addition to these functions, embodiments of the invention (through the delivery of an auto balance capability) further support the Intercompany process(es) by creating offset transactions using predefined Intercompany subsidiary AP and AR accounts. Embodiments of the invention minimize the set-up required for handling cross-subsidiary transactions; in some embodiments, this is accomplished by using a Trade Configurator and Global Trading Register, Global Trading Register Records, operational Intercompany Frameworks records, Cross Subsidiary Charge capability, schedulable Accounting “true up” functionality, automated Intercompany elimination and settlement features, and an Intercompany Journal Entry data record. The combination of these features and functions provide a comprehensive solution that can be used by all tenants of a data processing platform regardless of size, number of subsidiaries or location.

Embodiments of the inventive system provide a user with the capability to model cross-entity business processes while managing the implied cross-subsidiary accounting obligations that are required by GAAP standards and also implement the cost and/or revenue strategies (which are often used to minimize taxes) that a company's financial staff choose to satisfy those cross-entity obligations. Note that without such a system, a company is generally limited to a situation in which cross-subsidiary processes are not supported (due to the inherent complexity) or the process to satisfy the accounting/compliance/tax requirements is manual and tedious, requiring reports and analysis from financial teams.

In contrast, embodiments of the invention implement a generalized approach that business processes crossing subsidiary lines can elect to use and that reduces the amount of knowledge regarding accounting procedures required of the user, thereby enabling the automatic posting and netting of month-end entity-to-entity obligations. Conversely, embodiments of the inventive the system allow the financial staff of a business to focus on the accounting impact of a transaction and not be as concerned with the details of the business operations (i.e., how a cross-subsidiary fulfillment occurs). Further, the automation and abstraction aspects make the framework easy to use, consistent and adaptable to new workflows.

As an example, a use case in which an embodiment of the inventive system and methods may provide benefits compared to conventional approaches is the following relatively simple business process:
A sales transaction in a retail store (shop) in the UK;
The transaction is for a home theatre/automation system that needs to be delivered to the customer's home; the transaction includes an associated telephone-based installation and support service;
In a single store or even a single jurisdiction scenario, this is relatively simple—the customer takes the product off the shelf or the store arranges for it to be delivered;
However, as businesses globally expand, there can be much more complexity. For example, the situation may be the following when dealing with an organization that maintains certain primary functional operations in different jurisdictions;
   The retail store needs to place the order with their central distribution center in the Netherlands—a separate legal entity;
   Upon receipt of the order, the distribution center initiates their part of the fulfilment process;
   Upon fulfilment and shipping the item back to the UK store, the distribution center issues their invoice;
   The distribution center also has to make sure they track the transaction for purposes of various tax, safety or other governmental regulations and reporting responsibilities;
   The retail store receives the product and arranges for delivery to the customer;
   The retail store also has to capture the Vendor Bill transaction and handle the associated local reporting obligations for taxes or other regulatory concerns in that location;
In addition, because there is a service or customer support aspect to this sale, a purchase order is generated and sent to the Dublin, Ireland service center to enable them to initiate the process of tracking the job and providing the customer support services;
Once the delivery is completed, a service agent makes a call to the customer and handles the installation process; and
Behind the scenes, the service center invoices the retail store for their services—which creates another step for the retail store to capture the transaction and ensure that it is properly processed.

As is evident, even this relatively simple scenario creates a set of activities that are required for purposes of compliance with regulations, tracking of events, and reconciliation of various business functions that are located in multiple countries or jurisdictions (which may have differing tax, accounting, safety, consumer protection or other types of regulations). Now consider what happens as this type of transaction scales and a business chooses to concentrate certain operations in certain locations (whether because of competitive advantages, regulatory preferences, etc.); the business is now selling to more customers in more jurisdictions, through more retail stores located in more jurisdictions, and using multiple distribution and customer service centers in more jurisdictions in order to fulfill the orders. This has the potential of requiring a significant amount of manual effort to properly account for the various entities involved and to ensure compliance with applicable regulations.

However, as recognized by the inventors, much of the accounting, revenue recognition, and taxation processes are rules based, which suggested to them that aspects of the processes could be automated. In some sense, embodiments of the inventive system and methods automate many of the complex, and typically manually implemented inter-subsidiary processes that are required because of differing regulations, accounting, taxation, revenue recognition, and other rules that exist in different jurisdictions. Further, as a result of the data model and data structures utilized by embodiments of the inventive system and methods, cross jurisdictional reconciliation and other processes are made more efficient and accurate than would result from reliance on conventional approaches to processing aspects of a transaction that involves operating units located in multiple jurisdictions (or which are otherwise subject to different accounting or other rules or regulations).

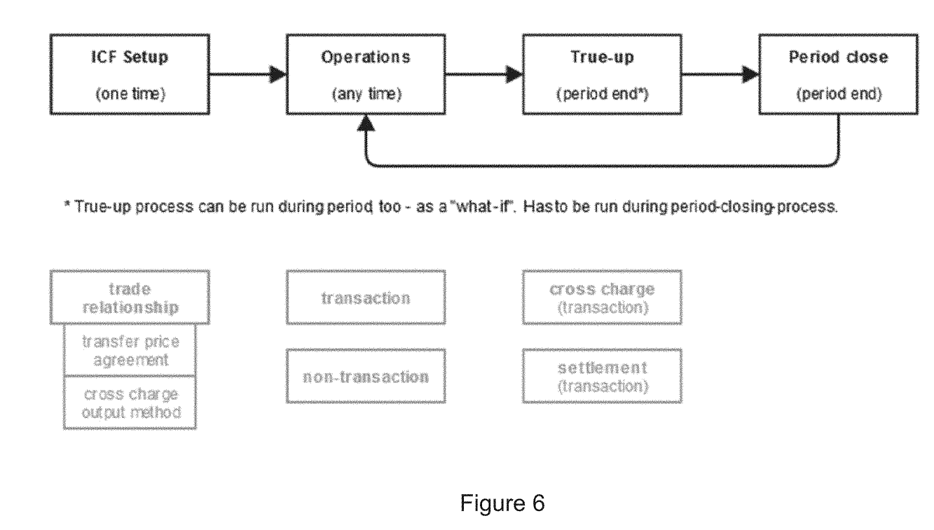

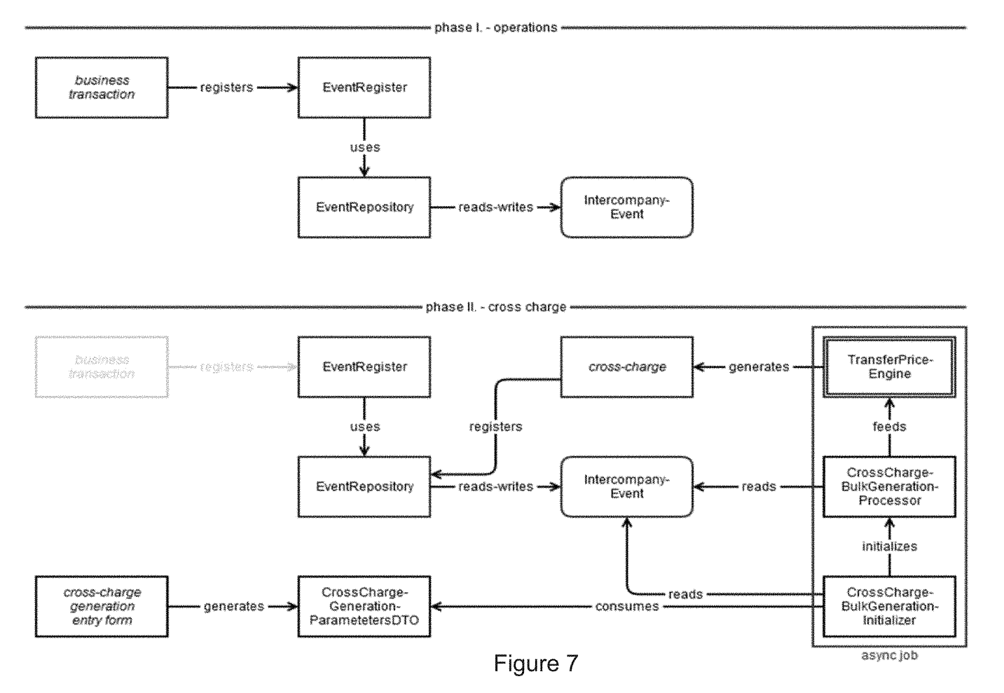

In some embodiments, the inventive system and methods may include the following operations or functional capabilities (note that aspects of these are illustrated in FIGS. 6 and 7):
1. Metadata creation/editing—this capability allows the system administrator/tenant to define the parameters of trading relationships between the organizational entities.
   a. In one example, this may be based on defining a “Global Trading Relationship” structure to represent the allowable trades/interactions and allow configuration of the rules of how the Intercompany obligations would be resolved (i.e., Journal entries, Invoicing, clearing house, transfer pricing, G/L Accounts);
2. Runtime Event Generation—this serves to extend the Operational workflows to flag an event whenever a workflow crosses subsidiary/entity boundaries.
   a. This feature is important because it allows the operational workflow implementation to be made agnostic with respect to the respective accounting/finance requirements; i.e., the implementer of a cross-subsidiary inventory fulfillment action need only indicate/signal that the Sale and the Item fulfillment for a given transaction workflow originate from two distinct legal entities;
3. Financial Automation—this operates to create an “engine” that can consume the Events raised in (2) and apply the rules defined/outlined in (1) as to how these entities are configured to collaborate, and in response, output accounting records or entries that meet legal/tax/finance requirements relevant to the cross-entity workflows.
   a. The engine may be executed at the time of the workflow events, or can be scheduled to resolve on a defined schedule (e.g., daily, weekly, monthly). As such, the outputs of the engine may be either granular or summarized; i.e., the engine could post true-up entries individually for each operational cross-entity instance or may generate an intercompany invoice that batches an entire weeks' worth of cross-sub activity;
   b. The engine consumes events in a way that it is agnostic to the operational details. Its job is to read the configuration in the trade relationship to be able to respond to the operational events abstractly; i.e., this subsidiary did something that causes it to owe another subsidiary a certain amount, or requires the creation of a certain type of record.
      Note that the system is very extensible; as new operations are defined, it is quite simple to enable them to work cross-sub/entity since all they need to do is raise an event. The engine is generic and powerful since it does not require any new logic to support an additional workflow, as it too is agnostic with regards to the operational details.

An example of one possible use case or implementation environment for an embodiment of the inventive system and methods is that of a multi-tenant system or data processing platform of the type described herein. This setting provides a useful example as such platforms store and process relatively large amounts of data for operating companies who are tenants of the platform. Embodiments of the inventive system and methods provide benefits and advantages if such an operating company has business units located in more than a single country or jurisdiction. These benefits and advantages arise at least partially by virtue of the underlying data model or schema used to implement the described multi-tenant system (as will be described in greater detail later in this document).

A multi-tenant architecture provides a means for multiple accounts (tenants) and users to store and access their data, and to utilize specific applications that reside on a remote platform. The platform is typically implemented as a set of servers or server groups, and is administered and operated by another party (such as the assignee of the present application) that provides use of the platform infrastructure as a service to the accounts and each account's users. This service may provide data storage, computational processing power, data analytics, and applications or workflows that may be executed with reference to an account's data (in whole or in part, and account-wide or user-specific). In some cases, such services have been described as Software-as-a-Service (SaaS), cloud-based services, web-services, or remote (“in the cloud”) services.

The applications that reside on a platform may be used to process certain of a user's data by instantiating an occurrence of the application within the user's account; for these types of uses, the applications may include ones utilized to operate a business, such as ERP, CRM, HR (HCM), eCommerce, and financial applications. Tenant customizations to the operation of the architecture may include custom functionality (such as the capability to perform tenant or user-specific functions, workflows, data processing, or operations) built on top of lower level operating system functions.

Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

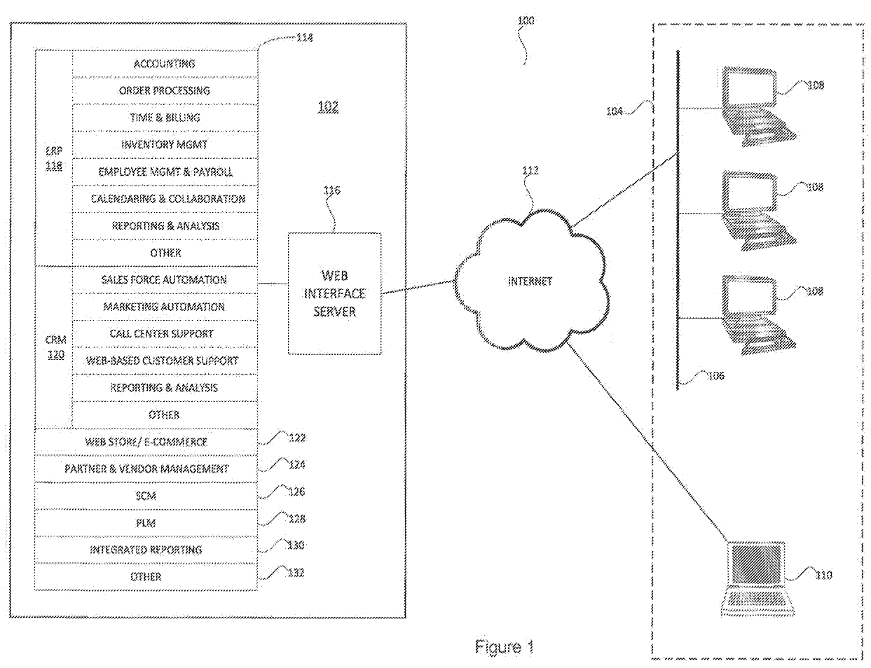

As noted, in some embodiments, the invention may be implemented in the context of a multi-tenant, “cloud” based environment (such as a multi-tenant business data processing platform), typically used to develop and provide Internet/web-based services and business applications for end users. This exemplary implementation environment is described with reference to FIGS. 1-3. As will be mentioned, embodiments of the invention may also be implemented in the context of other computing or operational environments or systems, such as for an individual business data processing system, a private network used with a plurality of client terminals, a remote or on-site data processing system, another form of client-server architecture, etc.

FIG. 1 is a diagram illustrating a system 100 in which an embodiment of the invention may be implemented. Enterprise network 104 may be associated with a business enterprise, such as a retailer, merchant, service provider, or other type of business. Alternatively, and in accordance with the advantages of an application service provider (ASP) hosted integrated business system (such as a multi-tenant data processing platform), the business enterprise may comprise fewer or no dedicated facilities or business network at all, provided that its end users have access to an internet browser and an internet connection. For simplicity and clarity of explanation, the enterprise network 104 is represented by an on-site local area network 106 to which a plurality of personal computers 108 are connected, each generally dedicated to a particular end user, such as a service agent or other employee (although such dedication is not required), along with an exemplary remote user computer 110 that can be, for example, a laptop computer or tablet computer of a traveling employee having internet access through a public Wi-Fi access point, or other internet access method. The end users (consumers) associated with computers 108 and 110 may possess an internet-enabled smartphone or other electronic device (such as a PDA, tablet, laptop computer) having wireless internet access or other synchronization capabilities. Users of the enterprise network 104 interface with the integrated business system 102 across the Internet 112 or another suitable communications network or combination of networks.

Integrated business system 102, which may be hosted by a dedicated third party, may include an integrated business server 114 and a web interface server 116, coupled as shown in FIG. 1. It is to be appreciated that either or both of the integrated business server 114 and the web interface server 116 may be implemented on one or more different hardware systems and components, even though represented as singular units in FIG. 1.

In a typical example in which system 102 is operated by a third party for the benefit of multiple account owners/tenants, each of whom is operating a business, integrated business server 114 comprises an ERP module 118 and further comprises a CRM module 120. In many cases, it will be desirable for the ERP module 118 to share methods, libraries, databases, subroutines, variables, etc., with CRM module 120, and indeed ERP module 118 may be intertwined with CRM module 120 into an integrated Business Data Processing Platform (which may be single tenant, but is typically multi-tenant).

The ERP module 118 may include, but is not limited to, a finance and accounting module, an order processing module, a time and billing module, an inventory management and distribution module, an employee management and payroll module, a calendaring and collaboration module, a reporting and analysis module, and other ERP-related modules. The CRM module 120 may include, but is not limited to, a sales force automation (SFA) module, a marketing automation module, a contact list module (not shown), a call center support module, a web-based customer support module, a reporting and analysis module, and other CRM-related modules. The integrated business server 114 (or multi-tenant data processing platform) further may provide other business functionalities including a web store/eCommerce module 122, a partner and vendor management module 124, and an integrated reporting module 130. An SCM (supply chain management) module 126 and PLM (product lifecycle management) module 128 may also be provided. Web interface server 116 is configured and adapted to interface with the integrated business server 114 to provide one or more web-based user interfaces to end users of the enterprise network 104.

The integrated business system shown in FIG. 1 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet or a private “intranet” network. The server, and the services it provides, may be referred to as the “host” and the remote computers, and the software applications running on the remote computers, being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

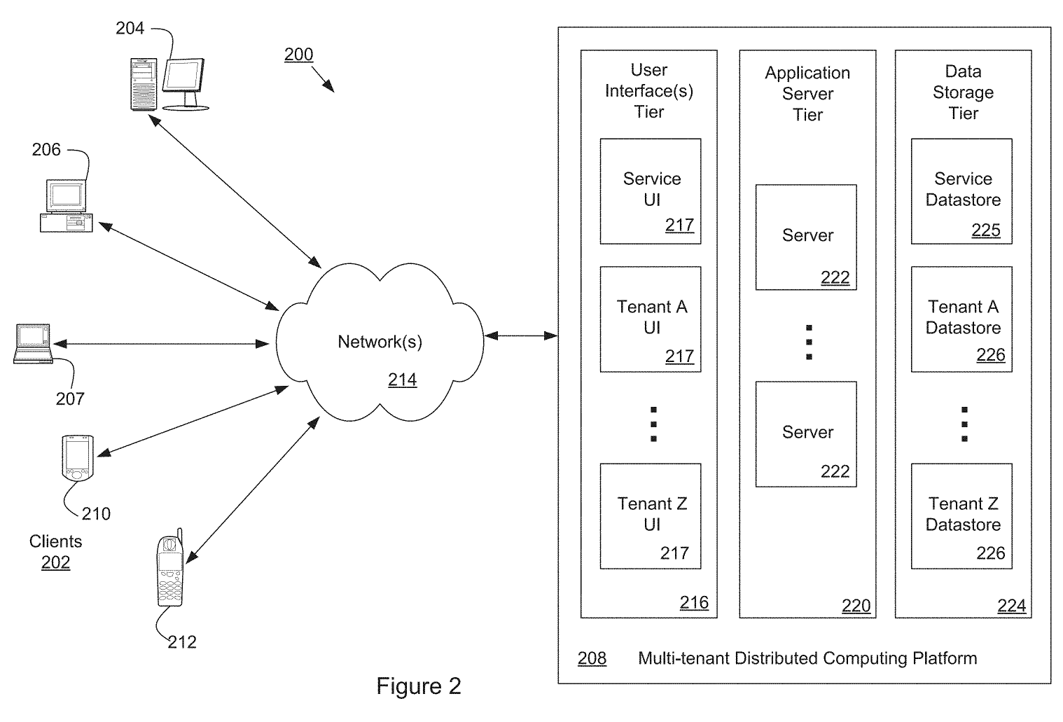

FIG. 2 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet). In use cases involving the delivery of customer support services, the computing devices noted represent the endpoint of the customer support delivery process, i.e., the consumer's device.

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure, where this interface may also or instead be used by an administrator of the platform to configure aspects of an account), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant or platform administrator to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 (which may contain data related to the configuration of an account or other aspect of the platform) and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 222 that are part of the platform's Application Server Tier 220.

Another business information system that may be provided as part of an integrated data processing and service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions.

In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system. Such functions or business applications are typically implemented by one or more modules of software code/instructions that are maintained on and executed by one or more servers 222 that are part of the platform's Application Server Tier 220.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform (such as platform 208 of FIG. 2).

As noted with regards to FIG. 1, the integrated business system shown in FIG. 2 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet or a private “intranet” network.

As suggested, rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users. Some of those multiple users may have distinct roles or responsibilities within the business or entity.

In some cases, a tenant may desire to modify or supplement the functionality of an existing platform application by introducing an extension to that application, where the extension is to be made available to the tenant's employees and/or customers. In some cases, such an extension may be applied to the processing of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as functionality associated with an eCommerce platform), a multi-tenant service platform may permit a tenant to configure certain aspects of the available service(s) to better suit their business needs. In this way, aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc. As will be discussed, such customizations may include establishing a specific set of rules for the processing and accounting aspects of an order that involves subsidiary entities, where those entities are subject to different regulations or other requirements.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from esthetic modifications to a graphical user interface to providing integration of components and/or entire applications developed by independent third party vendors. As noted, this can be very beneficial, since by permitting use of components and/or applications developed by third party vendors, a multi-tenant service can significantly enhance the functionality available to tenants and increase tenant satisfaction with the platform.

In addition to user customizations, an independent software developer (or the operator of a service platform) may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension. Further, the developer may wish to upgrade or provide a patch to the extension as they recognize a need for fixes or additional functionality that would be beneficial to incorporate into the extension. In some cases, the developer may prefer to make the upgrade available to only a select set of users (at least initially) in order to obtain feedback for improving the newer version of the extension, to test the stability of the extension, or to assist them to segment the market for their extension(s).

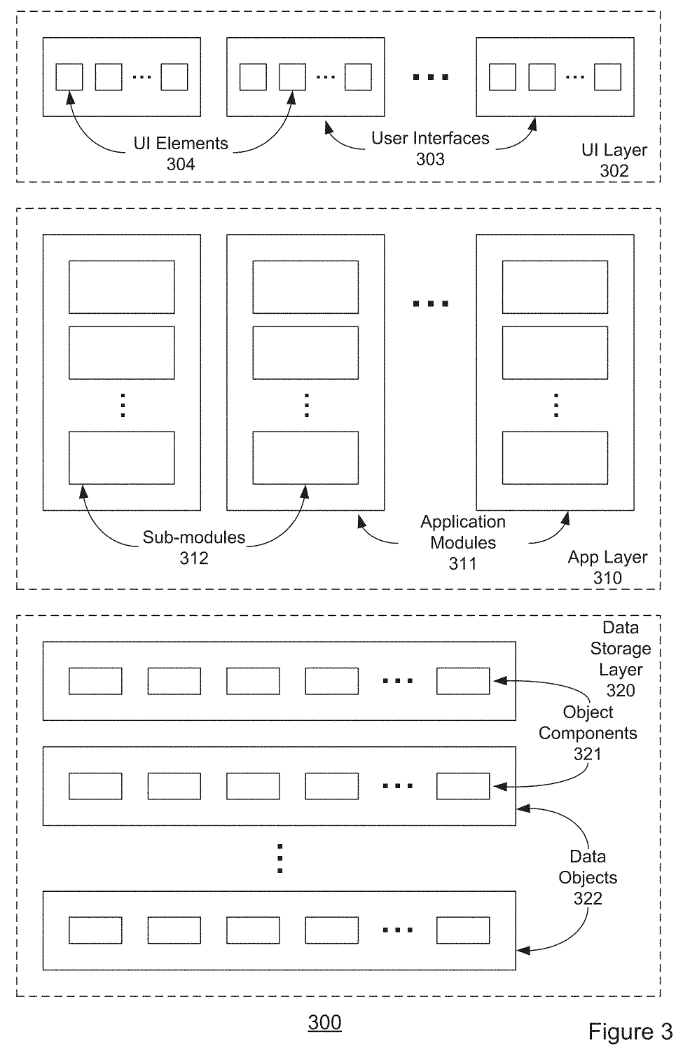

FIG. 3 is a diagram illustrating additional details of the elements or components of the multi-tenant distributed computing service platform of FIG. 2, in which an embodiment of the invention may be implemented. The software architecture depicted in FIG. 2 represents an example of a software system to which an embodiment of the invention may be applied. In general, an embodiment of the invention may be implemented using a set of software instructions that are designed to be executed by a suitably programmed processing element (such as a CPU, microprocessor, processor, controller, computing device, server, etc.). In a complex system, such instructions are typically arranged into “modules” with each such module performing a specific task, process, function, or operation. The entire set of modules may be controlled or coordinated in their operation by an operating system (OS) or other form of organizational platform.

As noted, FIG. 3 is a diagram illustrating additional details of the elements or components 300 of the multi-tenant distributed computing service platform of FIG. 2, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module (e.g., a function or process related to providing ERP, CRM, HR (HCM), eCommerce or other functionality to a user of the platform). Such function, method, process, or operation may also include those used to implement one or more aspects of the inventive system and methods, such as:
reconciliation of the tax, accounting or other legal or regulatory impact of the various functions implemented in fulfilling an order (such as those related to manufacture, environmental regulation, inventory management, delivery, set-up, training or customer support functions managed by entities within different jurisdictions);
internal tracking of the order processing through the different entities or subsidiaries involved, where some of those entities may be located in different jurisdictions;
construction or generation of business logic describing the desired workflow for the processing of a transaction and the tax, accounting, and financial treatment of the various aspects of the transaction (typically using a suitable user interface that is provided to enable a user to define a desired data processing workflow in terms of rules, tasks, conditions, tests, etc.)
   note that in some cases or implementations, an outcome of one or more of the rules or conditions used to implement the business logic may be determined by a value or values taken by specified business related data (such as ERP data related to inventory levels, a monetary value of inventory, a present value of a monetary exchange rate, etc.);
      in such cases, the rules or conditions may be expressed, in whole or in part, in terms of the real-time or pseudo real-time values of business related data (such as the ERP data referred to);
implementing a process to ensure that the applicable exchange rates, regulations, etc., are applied to one or more aspects of a transaction (as needed or required);
implementing a unified GRC (Governance, Risk, and Compliance Management) model that determines transaction approval routing and related thresholds as required, either by virtue of business or local compliance requirements, as well as tracking updates, status and GL (general ledger) posting changes in each entity's accounting records;
providing a real-time view of the global state of the business and cross-entity processes, taking into account the status of the business process in each entity (e.g., Order placed, Order pending fulfilment, Back-order of Inventory, etc.), thereby enabling management to track efficiency and provide business insight to users and customers/vendors; and
automated generation of necessary compliance documentation—e.g., electronic invoices (eInvoices), nota fiscal (Brazil), Fapio (China), etc., that meet local government requirements in support of the overall business process.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 2) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-3 are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed remotely over a network. Further example environments in which an embodiment of the invention may be implemented include devices (including mobile devices), software applications, systems, apparatuses, networks, or other configurable components that may be used by multiple users for data entry, data processing, application execution, data review, etc. and which have user interfaces or user interface components that can be configured to present an interface to a user.

Although further examples below may reference the example computing environment depicted in FIGS. 1-3, it will be apparent to one of skill in the art that the examples may be adapted for alternate computing devices, systems, apparatuses, processes, and environments. Note that an embodiment of the inventive methods may be implemented in the form of an application, a sub-routine that is part of a larger application, a “plug-in”, an extension to the functionality of a data processing system or platform, or any other suitable form.

In some embodiments or operational environments, and particularly in the context of an eCommerce platform, an important feature of the inventive system and methods is that the data used to represent the real-time (or substantially real-time) status of an organization is the same as that used by customers to browse inventory and to conduct purchase transactions. This arrangement prevents the need to utilize multiple data sources in order to obtain an accurate and complete representation of the organization's inventory and product availability, along with ensuring that all operating units rely on the same information regarding the status of an order.

Note that the inventive system or platform provides this and other benefits or advantages at least partially because of the underlying data schema and database structure. One implication of this architecture is that when a customer goes into a physical store, the product information brought up by a sales associate is the same data (i.e., the same instance of a product or product line) as a customer would find if they visited the organization's eCommerce web site. For example, the barcode that a sales associate scans in a physical store setting will bring up the same data record and information for the same instance of the product (i.e., the same fields and values in the database) as viewing the item on-line in the web-store would provide. The same is true for a customer service representative; the item record they view in the back end of the customer service system is the same and corresponds to the same item as the one the store representative sees, and as an eCommerce shopper sees.

As a result of the data structure and platform architecture utilized in some embodiments of the inventive system and methods, data such as item description, inventory level, profit margin, vendor/supplier, etc., are sourced from the same database (which may include copies that are synchronized) or data storage location(s), regardless of the origin of the information request. This means that any application or user seeking certain data will access the data from a singular location (or a properly synchronized location) in the database. Consequently, inventory data for warehouses and stores are available in the same place, as are the possible sources for more items and the data on orders in the supply chain system. This allows business logic to be formulated and applied on a case-by-case or per item basis, as well as on a more extensive basis (such as for a set or class of items or events).

Note that whereas in the preceding discussion, the relevant information or data is that related to an item or instance of a product or service, such a system also contains a set of information regarding each entity that is part of a business process executed by an entity or between multiple entities. This entity or subsidiary specific data may include one or more of entity location, relevant tax or other regulations, roles of users at a location, functional restrictions on an entity based on location or function, specific compliance requirements, etc. This means that cross-entity business rules and logic may be created and implemented, with such rules or logic being used to access and process data contained in the system data stores. This facilitates the tracking of transactions that implicate multiple entities and the execution of administrative or regulatory aspects of the transactions within a single integrated data processing system.

The business logic or rules may in some cases be made to depend on a value of one or more items of data that characterize the operation of the corporation. Such data may include ERP data (inventory levels, costs, inventory value, in-transit items, etc.) or financial data (revenues, profits, trends, etc.), for example. This permits a user to specify a rule or condition that is evaluated based on real-time or pseudo real-time business and operational data.

The rule or condition may also be used to specify a desired workflow that creates and processes data elements in order to comply with tax and/or accounting regulations or requirements, while also defining a desired workflow for purposes of internal business operations and management. This permits a business to maintain a desired set of operational capabilities while also satisfying relevant regulations.

Note that these features, advantages, and capabilities are not necessarily inherent in all multi-tenant or cloud-based systems. Rather, they arise from the single data source that the inventive system uses across all possible interactions, both internal and external (which results from implementing an integrated ERP, CRM, eCommerce, etc. based system that utilizes a single data source to provide synergistic and other benefits). Further, note that:
For eCommerce applications, having a single record associated with each item provides current (up-to-date) information about availability, sales, pricing, location, etc. on a per item basis; and
In general, having a database store data that is accessed by multiple types of applications is significant in enabling discovery of relationships between factors across the categories of data used in different applications (consumer spending, browsing, inventory levels, sales associates, messaging methods, methods of presenting information, etc.).

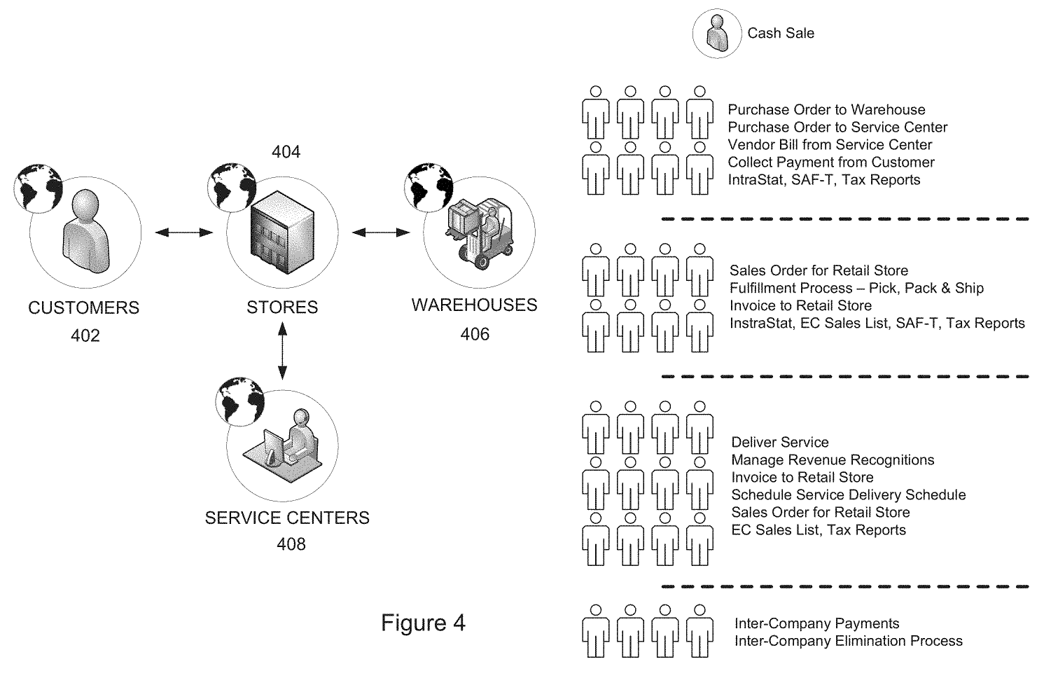

FIG. 4 is a diagram illustrating some of the processes involved in a use case of an embodiment of the inventive system and methods. As shown in the figure, a customer or customers 402 may access a commerce platform or system 404, which may include both physical and electronic commerce “stores”. Customers 402 may be located in one or more regions, countries, or jurisdictions. Similarly, “stores” 404 may be located or operating in one or more regions, countries, or jurisdictions. Fulfillment of an order placed by a customer 402 may include communications between stores 404 and warehouse 406 and/or between stores 406 and customer service centers 408. Fulfillment of an order may include process steps or functions related to:
generating a purchase order for transmission to a warehouse or inventory management system;
generating a purchase order for transmission to a customer service or customer support center
processing a payment obtained from the customer for the purchase of a product or service;
accounting for the proper currency exchange rate or rates involved;
accounting for the proper tax liabilities involved;
accounting for any relevant regulatory requirements involved;
arranging for packaging and shipping of a product; and
arranging for delivery of a product, etc.

As mentioned, the service platform contains data regarding (and provides support for) both “sides” or ends of the inter-subsidiary processes that are used in the stages of a transaction; as a result, embodiments provide a mechanism to allow businesses to create rules and to automate taking into account the impact across the various legal entities that are involved. Note that “inter-subsidiary” refers to entities, which may be divisions or operating units of the same multi-national organization, located in different jurisdictions or subject to different regulations, and not necessarily to completely independent companies.

FIG. 6 is a diagram illustrating an example overview of the data flow, characteristics, and operations that may be present in the processing of a transaction, where the processing is implemented in accordance with an embodiment of the inventive system and methods. As shown in the figure, a tenant may define how an intercompany transaction is processed or handled; this may include features such as selection of a transfer price agreement and the definition of a cross-charge process. FIG. 7 is a diagram illustrating additional details regarding the functions or operations that may be performed as part of the intercompany framework setup, operations, and true-up processes or functions shown in FIG. 6. As shown in the figure, events may trigger the generation of a data record (such as a cross-charge) which is then used as a basis for reconciling the cross-subsidiary aspects of a transaction.

As one example of a transaction that involves multiple operating units or subsidiaries located in, and subject to the rules of, different jurisdictions, consider the following scenario:
A UK (United Kingdom) based home theatre system provider is selling a home theatre system to a UK customer. Because the home theatre system is quite advanced and requires basic set-up and configuration to achieve the best entertainment experience, the transaction is actually a bundle sale with these two components:
   Home theatre hardware system at a price of GBP 1,000; and
   An over-the-phone consulting service basic configuration assistance, provided free of charge.
Assume that the transaction is subject to, or involves, the following aspects:
   Sales are administered from the UK HQ;
   Home theatre hardware is manufactured and transferred from NL (Netherlands) subsidiary warehouse to UK HQ, before being routed to the customer;
      The transfer price of this hardware from NL to UK is GBP 500;
      NL subsidiary Invoice is expressed in GBP, but must take into account the equivalent value in Euros with EU zero rated VAT to UK;
      NL invoice format with mandated wording for EC (European Community) Sales in UK;
      NL sub report—EC Sales;
      NL sub Report—Intrastat Dispatches (sales) in Euros;
      UK Sub report—Intrastat arrivals (purchases) in GBP;
   Over-the-phone consulting service is provided by a call center located in Dublin, Ireland

In terms of the process flow for the above example, the transaction may occur as a sequence of the following steps or operations (the implementation and impact of which may be properly accounted for by the application of one or more rules, logic, tasks, or workflow definition(s) that are specified by a user via a suitable user interface):

Step #1: UK Customer makes purchase from UK Store (generating 1 Order);
Step #2: Upon sales completion in the UK HQ, a centralized sale order (SO) will be created for this one customer, with the two line items noted. This SO will be identified as one requiring inter-subsidiary fulfilment from the NL Warehouse, which is a separate legal entity, and a pair of intercompany purchase orders (PO) will automatically be created for the hardware item and routed to UK HQ and the NL subsidiary respectively (this generates 1 PO (purchase order), 1 SO (sales order).
Note the following desirable aspects:
   System should provide the Customer with a “checkout” displaying local tax, currency, payment methods, etc. for their location;
   System knows that this company keeps its inventory in the NL Warehouse and is therefore able to automate the creation of the PO because the System has visibility into the supply chain as part of its capabilities;
   Upon recognizing that there is a PO from the UK HQ, the system automatically creates a SO pending fulfilment in the NL Warehouse Subsidiary and routes it to the Warehouse team for processing;
      Currency is determined or selected, and applicable taxation or service rates applied (e.g., UK Standard rate VAT and all in GBP);
         Step #3: NL subsidiary/warehouse pick/pack/ship items, to the UK Store (1 Fulfillment Process w/ 3 Steps, 1 Inter-subsidiary Invoice, 3 Tax Reports, 1 Inter-subsidiary Vendor Bill Entry)
Note the following aspects:
   Graphics/Screens may be used that show/update the fulfilment process;
   Completion of the fulfilment process shows a couple of important inter-subsidiary steps:
      Automatic generation of Inter-Subsidiary Invoice from the NL Legal Entity to the UK HQ subsidiary, with appropriate local tax, and intercompany/intercountry treatment;
      Automatic generation of balancing Inter-Subsidiary Bill in UK Legal Entity to capture costs re-allocated;
      In addition, in some embodiments, multi-book accounting may be utilized so that the UK, NL and other subsidiaries are using book specific functional currencies, show book specific GL impact, etc.

Below are shown a series of example ledger entries that represent the handling of the described cross-subsidiary transaction (and which may be defined or described by a set of rules or workflow definitions specified by a user using a suitable user interface).

### T-Account:

NL Fulfillment to External Customer, Assuming the COGS of this Item in NL is Euro 200.

| Subsidiary | Debit | Credit |
|---|---|---|
| NL | COGS EUR 200 | |
| NL | | Inventory EUR 200 |

This represents the recording of the Cost of the items being sold in the accounting records of the NL (Netherlands) entity.
Auto-Generated Intercompany Sales Invoice from NL to UK:

| Subsidiary | Debit | Credit |
|---|---|---|
| NL | Intercompany receivable | |
| | (Entity: UK customer in NL) | |
| | GBP 500 | |
| NL | | Intercompany revenue GBP 500 |

This represents the recording of the Sales price of the items being sold in the accounting records of the NL entity.
Auto-Generated Intercompany Vendor Bill from UK to NL:

| Subsidiary | Debit | Credit |
|---|---|---|
| UK | Intercompany expense | |
| | GBP 500 | |
| UK | | Intercompany payables |
| | | (Entity: NL vendor in UK) |
| | | GBP 500 |

This represents the recording of the cost of the items purchased by the UK (United Kingdom) entity from the NL entity in the accounting records of the UK entity.
Step #4: UK HQ will send the final invoice to the external customer. (1 Invoice, 1 Payment Capture)
Note the following aspects:
   System may automatically generate a Final Invoice to customer from UK subsidiary (along with payment capture); and
   System may also show or confirm that the appropriate tax reporting and compliance obligations are being satisfied (Tax Determination, Reports, Intrastat, EC-Sales, SAF-T, others);

### T-Account:

### Final Invoice to the External Customer:

| Subsidiary | Debit | Credit |
|---|---|---|
| UK | Receivable | |
| | (Entity: External customer in | |
| | UK) | |
| | GBP 1,200 | |
| UK | | Revenue 1,000 |
| | | VAT on Sales 200 |

This represents the recording of the sales transaction with the end customer in the accounting records of the UK entity.
Step #5: The customer receives the home theatre hardware, and calls the Dublin, Ireland customer-support call center to get the system configured. Upon the completion of this configuration service, the Dublin call center issues an inter-subsidiary sales invoice to the UK HQ, with a paired vendor bill on the UK side. (1 PO, 1 SO, 1 Invoice, 1 Bill Entry, plus the operational activities for making the installation call)
Note the following aspects:
   Assume that the Ireland subsidiary charges UK subs GBP 60 for this service;
   Generation of Inter-Subsidiary Invoice from the Dublin Legal Entity, with appropriate local tax, and intercompany treatment;
   Automatic generation of balancing Inter-Subsidiary Bill in UK Legal Entity to capture costs re-allocated; and
   UK subsidiary will record the appropriate VAT liability.
      Note that in this scenario, the customer service assistance is provided over the phone; this may be captured by a reverse charge from the Ireland to the UK company, with specific wording.

### T-Account:

Auto-Generated Intercompany Sales Invoice from IR to UK:

| Subsidiary | Debit | Credit |
|---|---|---|
| IR | Intercompany receivable | |
| | (Entity: UK customer in IR) | |
| | GBP 60 | |
| IR | | Intercompany revenue GBP 60 |

This represents the value of the services provided by the IR (Ireland) entity to the UK entity as recorded in the accounting records of the IR entity.
Auto-Generated Intercompany Vendor Bill from UK to IR:

| Subsidiary | Debit | Credit |
|---|---|---|
| UK | Intercompany expense GBP 60 | |
| UK | | Intercompany payables |
| | | (Entity: IR vendor in UK) |
| | | GBP 60 |

This represents the value of the services provided by the IR entity to the UK entity as recorded in the accounting records of the UK entity.
Step #6: While the previous steps have focused on the operational ERP aspects, it is important to note that behind the scenes it may be necessary to implement a process or processes to take care of the GL Impact and Financial aspects. In this regard, automation of the inter-subsidiary transaction-processing framework will auto-generate two pairs of inter-subsidiary invoices and bills:
NL sales invoice to UK, paired with vendor bill entered in the UK entity, on item #1; and
Ireland sales invoice to UK, paired with UK vendor bill to Ireland, on item #2.
   Step #7: A global business has to deal with elimination/settlement/global reporting of business processes across all entities (2 Intercompany Journal Entries (ICJE))
Note the following aspects:
   In this case, assume that the settlement of intercompany A/R and A/P balances can be done through a multi-subsidiary ICJE (with cash transferred out of a UK entity and allocated to NL and Ireland subsidiaries);
   Multi-tier approval routing on such a multi-subsidiary ICJE;
   Approval Routing is a key component of the capabilities that enable organizations to ensure that nothing is unexpected, untracked or unreported within their global business system;
   The appropriate entity in the context of the additional level of approval required for some countries (France, for example) may be indicated, so that once the ICJE is approved by the appropriate business leader it then goes to the French Controller for approval. Note the automation of the reversing and replacing entries.

### T-Account:

### We Will Create One Multi-Subsidiary ICJE to Settle the Intercompany Payables/Receivables Balance Between UK, IR and NL

| Subsidiary | Debit | Credit |
|---|---|---|
| UK | Intercompany payables | |
| | (Entity: NL vendor in UK) | |
| | GBP 500 | |
| UK | Intercompany payables | |
| | (Entity: IR vendor in UK) | |
| | GBP 60 | |
| UK | | Cash GBP 560 |
| NL | Cash GBP 500 | |
| NL | | Intercompany receivable |
| | | (Entity: UK customer in NL) |
| | | GBP 500 |
| IR | Cash GBP 60 | |
| IR | | Intercompany receivable |
| | | (Entity: UK customer in IR) |
| | | GBP 60 |

Conventional approaches used to process or reconcile transactions that involve entities located in multiple jurisdictions or regions are confronted with data access, integration, and compatibility issues. In addition, such approaches are generally unable to provide the benefits obtained by using embodiments of the inventive system and methods, where such benefits include those arising from one or more of:
synergistic combinations of organizational data;
access to a single source of “true” data for all operations within the system (and therefore current and consistent information regarding product types, pricing, availability, options, etc.);
real-time data values (as opposed to “batch”) or changes in value (for purposes of data “velocity” or rate based considerations); and
more efficient data access capabilities.
   Further, conventional approaches lack the ability to identify cross-functional relationships or correlations that may be of interest in executing a transaction and its associated operations (such as fulfillment, payment, inventory management, etc.).

As described, embodiments of the inventive system and methods may utilize access to various sources and types of business data when executing one or more operations related to a transaction. The data subjected to processing is obtained from a database containing data that provides an integrated representation of the current status of the operations of a company (e.g., inventory, sales, financials, subsidiary locations and responsibilities, etc.) and also of its previous, current, or prospective interactions with customers or prospective customers (via multiple channels or points of contact).

The customer-related records may include records of contacts, previous browsing and/or purchasing behavior, features accessed on an eCommerce web site, loyalty program participation, social network behavior, etc. Note that this is in contrast to conventional approaches which typically utilize separate data stores for each primary application or usage (such as ERP, CRM, Financials, Marketing, etc.), and thus prevent an application being able to access and process cross-functional data (and thereby may prevent identification of trends or events that suggest previously unrecognized or undervalued relationships).

Further, embodiments of the inventive system and methods utilize a record structure that associates each product or service on an eCommerce web site with its own data record. One result of this approach is that the location, status, or characteristics of an individual item may be determined with accuracy and consistency, whether the record is being accessed in a store, via a web site, in a warehouse, in-transit, etc.

Note that while multi-book accounting isn't required in order to implement embodiments of the inventive system and methods, in cases where multi-book accounting is required to ensure local accounting rules are handled correctly, the automated features of the invention provide an additional layer of efficiency by removing the manual effort required to achieve locally accurate and compliant accounting books. Note that in the examples presented, there is only one set of accounting entries. In a multi-book situation, it may be necessary to post the sales lines to separate accounts based on the tax codes/deliver address (country); embodiments of the inventive system and methods can perform this task automatically, thereby saving time and reducing potential errors.

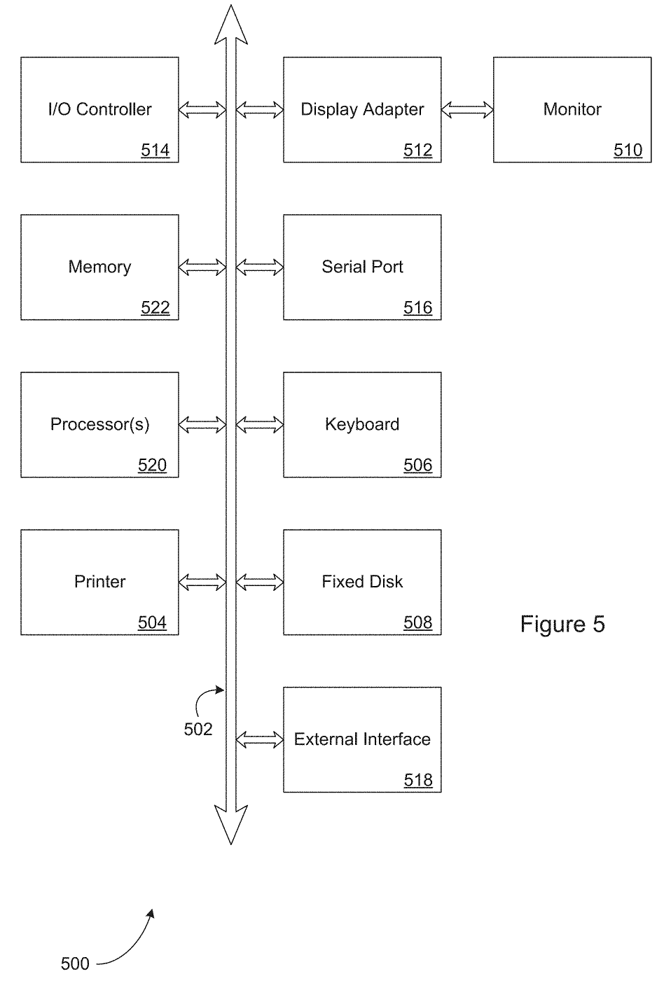

In accordance with one embodiment of the invention, the system, apparatus, methods, processes, functions, and/or operations described herein may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 5 is a diagram illustrating elements or components that may be present in a computer device or system 500 configured to implement a method, process, function, or operation in accordance with an embodiment of the invention. The subsystems shown in FIG. 5 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5 including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A data processing platform, comprising:
an application or applications installed on the data processing platform;
a tenant account configured to have access to an instantiation of the application or applications installed on the data processing platform;
a database storing data for the tenant account, the database including data records containing information regarding products and services offered to customers by the tenant, and data records containing information regarding each of the entities that are part of the tenant's business organization;
an electronic processing element programmed with a set of computer-executable instructions, which when executed, cause the platform to
provide a user of the tenant account with an interface for specifying a workflow to be used for processing a transaction initiated by a customer of the tenant, wherein the workflow includes an action performed by at least two entities that are part of the tenant's business organization;
based on the workflow, generate one or more data records for the transaction, the generated records including records used to satisfy relevant legal or accounting requirements;
access data stored in the database relating to the at least two entities that are part of the tenant's business organization, wherein the accessed data includes one or more of an entity's location or an entity's currency; and
based on the workflow and the accessed data, process the transaction.

2. The data processing platform of claim 1, wherein the application or applications installed on the platform are one or more of an ERP application, a CRM application, a HR application, an eCommerce application, or a financial application.

3. The data processing platform of claim 1, wherein the data records containing information regarding each of the entities that are part of the tenant's business organization include one or more of information regarding the location, currency, and relevant accounting requirements of each entity.

4. The data processing platform of claim 1, wherein the workflow is expressed, at least in part, in terms of one or more rules, conditions, actions, or events satisfied or performed by at least one of the at least two entities that are part of the tenant's business organization.

5. The data processing platform of claim 4, wherein the one or more rules, conditions, actions, or events depend, at least in part, on business-related data associated with the tenant account.

6. The data processing platform of claim 5, wherein the business-related data associated with the tenant account includes data regarding one or more of revenue, sales, profit, or inventory.

7. The data processing platform of claim 4, wherein the one or more rules, conditions, actions, or events determine how to allocate or reconcile costs, fees, or revenues involved in the transaction.

8. The data processing platform of claim 1, wherein the at least two entities that are part of the tenant's business organization are subject to different legal structures.

9. The data processing platform of claim 1, wherein the at least two entities that are part of the tenant's business organization include one or more of subsidiaries, functional units, manufacturing sites, sales support sites, customer service sites, or order fulfillment sites of the business organization.

10. The data processing platform of claim 1, wherein generating one or more data records for the transaction includes generating a record of one or more of an intercompany journal entry, a sales order, a local tax amount, a customer service request, an invoice, or a vendor bill.

11. A method of processing a transaction where portions of the transaction are performed by different entities of a business organization, comprising:
providing a user with an interface for specifying a workflow to be used for processing the transaction, wherein the workflow includes an action performed by at least two entities that are part of the business organization and that are subject to differing requirements;
receiving from the user a selection or identification of one or more functions, operations, processes, or actions to be performed;
based on the received functions, operations, processes, or actions to be performed, generate one or more data records for the transaction, the generated records including records used to satisfy relevant legal or accounting requirements;
access data stored in a database relating to the at least two entities that are part of the business organization, wherein the accessed data includes one or more of an entity's location or an entity's currency; and
based on the workflow and the accessed data, process the transaction, wherein processing the transaction includes populating the generated data records in order to satisfy the relevant legal or accounting requirements.

12. The method of claim 11, wherein the different requirements are one or more of different legal, tax, revenue recognition, or accounting requirements.

13. The method of claim 11, wherein the transaction arises out of a customer accessing an eCommerce application that is operated by, or for, the business organization.

14. The method of claim 11, wherein the data stored in a database relating to the at least two entities that are part of the business organization include one or more of information regarding the location, currency, or relevant legal or accounting requirements of each entity.

15. The method of claim 11, wherein the workflow is expressed, at least in part, in terms of one or more rules, conditions, actions, or events satisfied or performed by at least one of the at least two entities that are part of the business organization.

16. The method of claim 15, wherein the one or more rules, conditions, actions, or events depend, at least in part, on business-related data associated with the business organization.

17. The method of claim 16, wherein the business-related data associated with the business organization includes data regarding one or more of revenue, sales, profit, or inventory.

18. The method of claim 15, wherein the one or more rules, conditions, actions, or events determine how to allocate or reconcile costs, fees, or revenues involved in the transaction.

19. The method of claim 11, wherein the at least two entities that are part of the tenant's business organization include one or more of subsidiaries, functional units, manufacturing sites, sales support sites, customer service sites, or order fulfillment sites of the business organization.

20. The method of claim 11, wherein generating one or more data records for the transaction includes generating a record of one or more of an intercompany journal entry, a sales order, a local tax amount, a customer service request, an invoice, or a vendor bill.
